(19) United States
(12) Patent Application Publication
(10) Pub. No.: US 2011/0107314 A1
(43) Pub. Date: May 5, 2011

(54) STATIC CODE RECOGNITION FOR BINARY TRANSLATION

(76) Inventors: Boris Artashesovich Babayan, Moscow (RU); Igor Stanislavovich Zamyatin, Moscow (RU); Dmitry Yurievich Polukhin, Moscow (RU)

(21) Appl. No.: 13/001,423

(22) PCT Filed: Jun. 27, 2008
(86) PCT No.: PCT/RU08/00402

§ 371 Date: Dec. 26, 2010

(51) Int. Cl. G06F 9/44

(52) U.S. Cl. 717/132

(57) ABSTRACT

In one embodiment, the present invention includes a method for creating a control flow graph (CFG) node for a starting address, parsing code beginning at the starting address until a control transfer is encountered and statically determining a destination address for the control transfer, and creating a CFG node for the destination address, and parsing code beginning at the destination address. In this way, virtually all executed code of an application can be recognized. Other embodiments are described and claimed.

### BACKGROUND

Binary translation is used to translate a source binary executable, which corresponds to code compiled for a source machine, to a binary executable to execute on a target machine (a target binary executable). For example, different computer systems can operate using different instruction set architectures (ISAs) and as such, code written for a first ISA must be translated to execute on a second system having a second ISA. Binary translation thus acts to translate code (i.e., an image) of an executable from one machine to equivalent code for another machine. Another application of binary translation is to translate code from one ISA to the same ISA, for performing different kinds of code optimizations.

Certain code syntax of some code can make this translation difficult. For example, binary code often mixes data and instructions in such a way that they cannot be distinguished. This problem is exacerbated by control transfers such as indirect or indexed jumps, where a runtime target address of the jump may be hard to determine statically, even though it will be known at runtime. Translation first performs code recognition to recognize the instructions and data present in the source image, and then translates the recognized instructions to another ISA. However, full code recognition for many ISAs (x86 code, for example) is difficult because of indirect branches.

### BRIEF DESCRIPTION OF THE DRAWINGS

FIG. 1 is a flow diagram of a method in accordance with one embodiment of the present invention.

FIG. 2 is a flow diagram of a method of code parsing in accordance with one embodiment of the present invention.

FIG. 3 is a block diagram of a system in accordance with an embodiment of the present invention.

### DETAILED DESCRIPTION

Embodiments may be used to allow easy recognition of entire code that is actually executed in a statically linked binary file without launching of an application, i.e., statically. “Actually executed” code means the code that would be executed during a runtime launching of an application.

Given a statically linked executable on a given operating system (OS), e.g., a Windows or Linux™ OS, data and code of the binary may be explored using various heuristics in order to parse the code. As one example, constants that could serve as actual destination addresses may be ascertained. Then from those addresses, code may be attempted to be parsed. The result of such operations is to find the entire code to be actually executed and build a consistent control flow graph (CFG) related to that code. At the same time, various filtering and other heuristics may be applied to try to minimize any false code that may be found during such recognition.

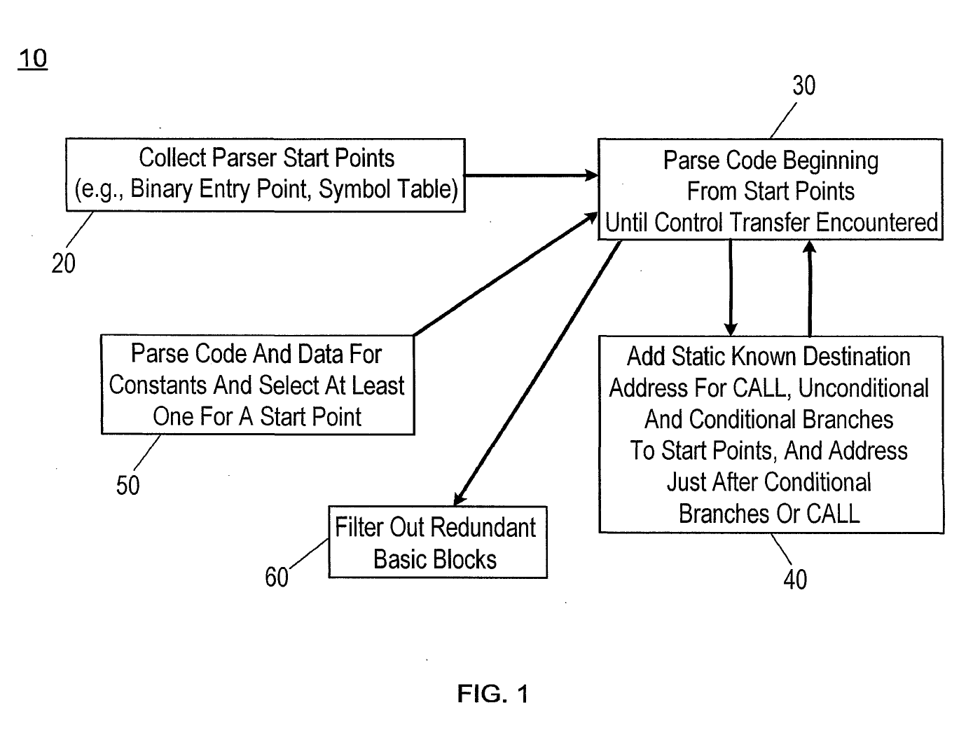

Referring now to FIG. 1, shown is a flow diagram of a method in accordance with one embodiment of the present invention. As shown in FIG. 1, method 10 may be a high level view of an algorithm to perform static binary translation using code recognition in accordance with an embodiment of the present invention. As shown in FIG. 1, method 10 may begin by collecting parser start points (block 20). While the origin of such start points can vary, in some implementations these start points may be binary entry points, addresses obtained from a symbol table (symtab), or other such start points. Then, code may be parsed based on these start points (block 30). In one embodiment, code parsing may be performed using a given disassembly tool. Code parsing may thus be performed in block 30 until a given control transfer operation is encountered. For example, such operations may correspond to call or return instructions, conditional or unconditional branches and so forth.

With respect to such control transfer operations, an iterative interaction between block 30 and a block 40 may occur. Specifically, at block 40 if there is a statically known destination address for the transfer, such address(es) may be added as start points to thus perform further code parsing at block 30. Similarly, code parsing may also begin at addresses occurring immediately after certain control transfer instructions such as conditional branches or calls.

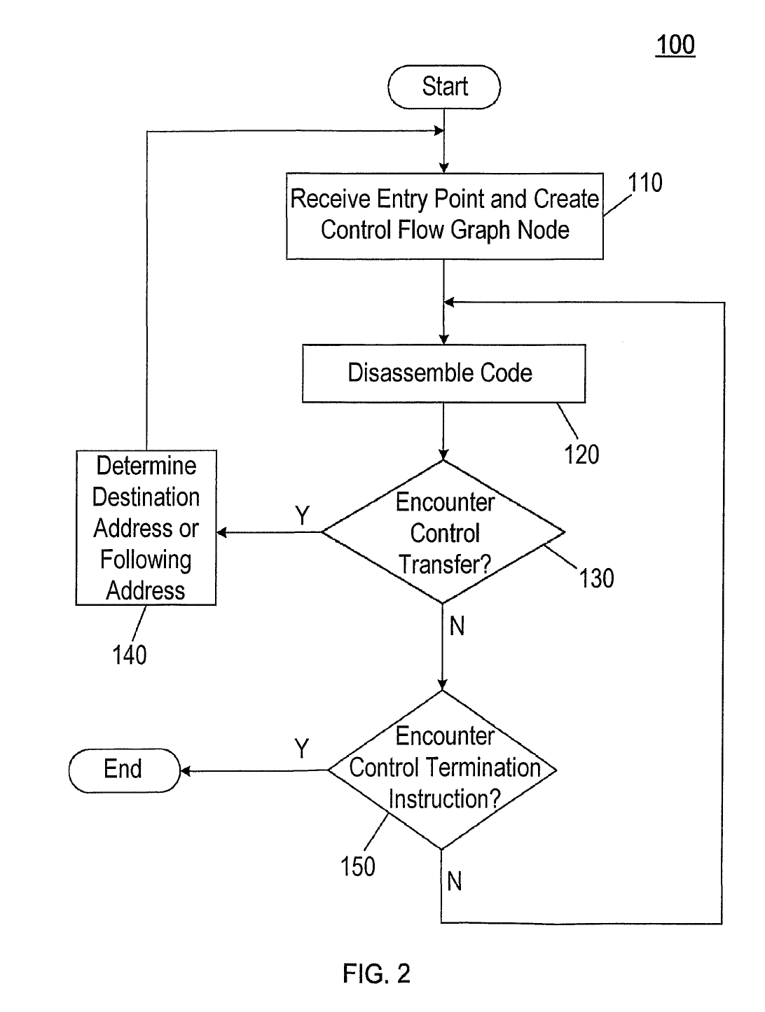

Additionally, code and data of a binary may be parsed for constants (block 50). These constants that are obtained may also be used to begin parsing at block 30, with the constants as start points. One embodiment of such parsing is described below with regard to FIG. 2.

Due to the various parsing operations that are performed at different starting addresses based on entry points, control transfer operations, or discovery of constants, some of these parsing operations may be for invalid code segments and/or redundant basic blocks. Accordingly, at block 60 such redundant basic blocks may be filtered out. Different heuristics used for filtering will be discussed below. While shown with this particular implementation in the embodiment of FIG. 1, the scope of the present invention is not limited in this regard.

Different manners of performing code parsing may be performed. Referring now to FIG. 2, shown is a flow diagram of a method of code parsing in accordance with one embodiment of the present invention. As shown in FIG. 2, method 100 may begin by receiving an entry point (block 110). As discussed above, this entry point may be an entry point for a binary, an address with functions from a symbol table, if available. Still further as will be discussed below, additional entry points may be received based on other considerations or results of code parsing. For each such entry point received, a CFG node may be created. For this node, the code following this entry point may be disassembled (block 120). As an example, a given disassembly tool may be used to disassemble code starting from the entry point to fill the CFG node with parsed instructions.

It may be determined during such code disassembly whether a control transfer is encountered (diamond 130). For example, a control transfer may correspond to a call, conditional or unconditional branch or so forth. If so, control passes to block 140 where a destination address may be determined for the control transfer, or a following address, i.e., an address immediately after a call or conditional branch instruction may be determined. As shown in FIG. 2, these determined addresses may be provided back to block 110 as additional entry points for creation of further CFG nodes.

As further shown in FIG. 2, during further code disassembly, it may be determined whether a control termination instruction is encountered (diamond 150). For example, such instructions may be return (RET) instructions, halt (HLT) instructions, interrupt (INT) instructions or so forth. If so, the code parsing of that CFG node may conclude, otherwise control passes back to block 120.

Thus as shown in FIG. 2, initial information may be gathered for code parsing, e.g., an entry point of the binary, addresses of the functions from the symbol table (if symtab is available), and so forth. Then the code is parsed using gathered information and a CFG is created in the following way: the entry point is the new CFG node; code is disassembled starting from the entry point and the CFG node is filled with parsed instructions; when a CALL, conditional or unconditional branch is encountered, the destination address may be determined and used as a new entry point (or the address that is just after CALL or conditional branch issued as an entry point); and finally, code parsing is stopped when an issued instruction such as RET, HLT, INT, is encountered.

For further code parsing opportunities, each byte of data and code segments can be considered as a start point for a location of some constant, which is a potential entry point for code parsing. Then code parsing, e.g., in accordance with method 100 of FIG. 2 may be performed from this address. As one example of choosing constants a part of a data segment obtained by a tool (such as an object dump) is as follows:

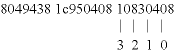

Potential entry points here are:

Starting from byte number 0—08048310

Starting from byte number 1—04831008

Starting from byte number 2—83100804

Starting from byte number 3—10080495 etc. . . . \

Thus this arbitrary byte sequence (expressed as a sequence of 4-byte hexadecimal values) may be parsed by a tool to select a 4-byte constant as a new entry point starting from each byte.

As a result of taking into consideration each byte and beginning code parsing from it, a large number of CFG nodes will be generated that actually do not contain valid code. Or nodes may intersect each other, and it cannot be determined which of the “concurrent” nodes is valid. Such “redundant” nodes may be properly filtered out.

Since code is disassembled from arbitrary points, a CFG node may be obtained that contains instructions that could not be met in the real code. Here is an example node in Table 1 (from a Windows application) that contains some invalid instructions:

TABLE 1

| | |
|---|---|
| 0040bea0 00 00 | add byte ptr [eax],al // non-real instruction, as will |
| be | |
| described below. | |
| 0040bea2 00 C7 | add bh,al |
| 0040bea4 44 | inc esp // privileged instruction |
| 040bea7 01 00 | add dword ptr [eax],eax |
| 0040bea9 00 00 | add byte ptr [eax],al // non-real instruction |
| 0040beab 89 15 80 32 58 00 | mov dword ptr [0x583280],edx // instruction with |
| explicit | |

```
  memory reference to non-actual application memory (here 0x583280 is not a valid
  memory address)
```

The filtering algorithm uses the fact that a really valid CFG node (i.e., node which indeed contains valid code of the application) cannot branch to another CFG node that is itself invalid. In one embodiment, the following list of heuristics may be used for filtering out CFG nodes: mark as invalid (i.e. exclude from resulting CFG) those nodes which contain a “zero” instruction, i.e., an instruction that encodes as 00 00, as this byte sequence relates to an instruction “add byte ptr [eax],al” which has no sense for x86 code and usually is not produced by any compiler; mark as invalid the nodes that contain privileged instructions, e.g., in, out, call far, etc. (note that this heuristic works only for user mode applications); mark as invalid the nodes for which during disassembling their instructions caused a decoder error; mark as invalid the nodes that contain instructions with explicit memory references that are not to actual application memory; iteratively mark as invalid the nodes that are the predecessors of an invalid node (i.e., take an invalid node, walk through its predecessors, mark them invalid and do the same procedure for them). Note that this iterative process may be performed after previous heuristics. Finally, mark as invalid the nodes that are still valid after the last heuristic but have no successors, and have all invalid predecessors.

To verify code recognition in accordance with an embodiment of the present invention, information from a symbol table may be used. First look up functions, e.g., function f1, f2, . . . fN in symtab with start addresses A1, A2, . . . AN, respectively. The generated CFG may be scanned to find valid basic blocks that start from A1, A2, . . . AN. Those basic blocks are the start blocks of the corresponding function. Next, determine basic blocks that finish the corresponding function to make sure that this function's code has been exactly found, e.g., by looking at a disassembler listing. Then, calculate the size of all such found functions (S1), and the size of entire valid code that is found, i.e., it is the size of all valid nodes in the CFG (S0). Next, calculate the difference between S0 and S1 (D0). Finally, calculate the percentage of difference for entire valid code found, i.e., 100*D0/S0. In this way, a close estimation of the redundant code can be obtained, and which is about 2% in average for spec2000 tests. Thus, in this way, in spite of all the difficulties of static x86-code recognition, it is possible to recognize virtually all executed code of an application, by parsing the code and data for possible entry points and applying heuristics for filtering out redundant code.

Current binary systems (static or dynamic) and disassemblers do not solve the problem of recognizing the actually executed code in static code parsing, as typically dynamic support is used to solve the problem of indirect control transfers during code recognition. In contrast, embodiments do not use any dynamic support, and thus may reduce overhead for full dynamic binary systems. Embodiments may be implemented as a part of front end for a binary translation system of a processor. Such a processor may have its own ISA, and may include hardware support for binary translation from an x86 ISA to its internal ISA.

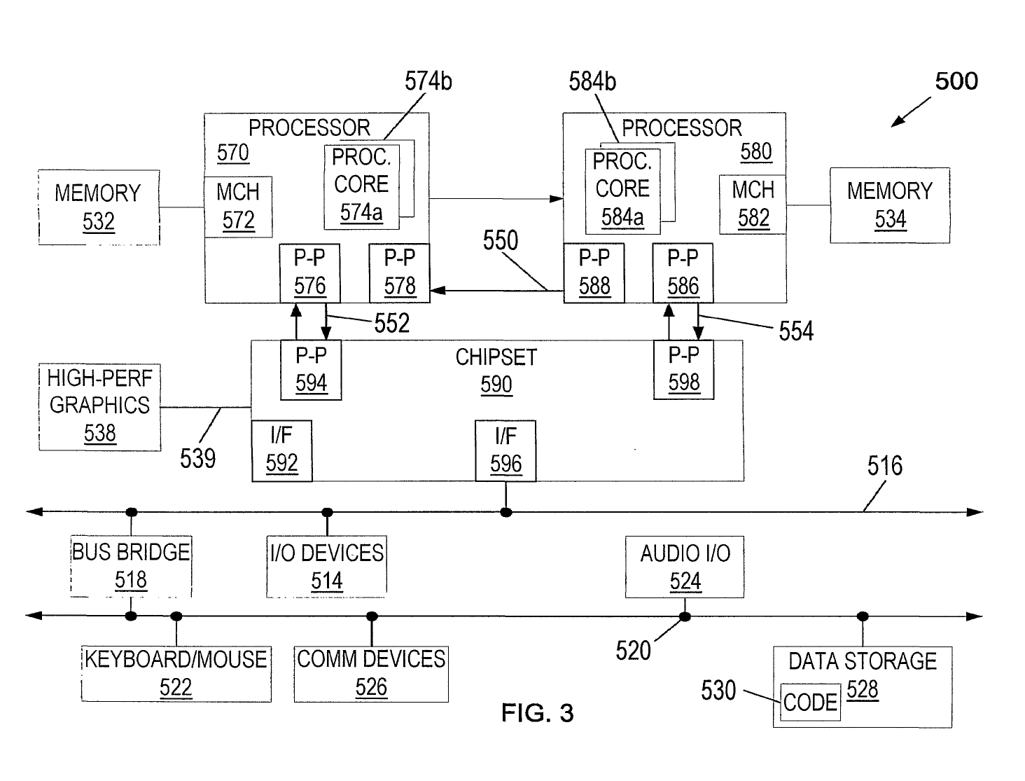

Embodiments may be implemented in many different system types. Referring now to FIG. 3, shown is a block diagram of a system in accordance with an embodiment of the present invention. As shown in FIG. 3, multiprocessor system 500 is a point-to-point interconnect system, and includes a first processor 570 and a second processor 580 coupled via a point-to-point interconnect 550. As shown in FIG. 3, each of processors 570 and 580 may be multicore processors, including first and second processor cores (i.e., processor cores 574a and 574b and processor cores 584a and 584b), although potentially many more cores may be present in the processors. The processor cores, which may be vector processors, may include a binary translator in accordance with an embodiment of the present invention to perform code recognition as described above.

Still referring to FIG. 3, first processor 570 further includes a memory controller hub (MCH) 572 and point-to-point (P-P) interfaces 576 and 578. Similarly, second processor 580 includes a MCH 582 and P-P interfaces 586 and 588. As shown in FIG. 2, MCH's 572 and 582 couple the processors to respective memories, namely a memory 532 and a memory 534, which may be portions of main memory (e.g., a dynamic random access memory (DRAM)) locally attached to the respective processors. First processor 570 and second processor 580 may be coupled to a chipset 590 via P-P interconnects 552 and 554, respectively. As shown in FIG. 3, chipset 590 includes P-P interfaces 594 and 598.

Furthermore, chipset 590 includes an interface 592 to couple chipset 590 with a high performance graphics engine 538, by a P-P interconnect 539. In turn, chipset 590 may be coupled to a first bus 516 via an interface 596. As shown in FIG. 3, various input/output (I/O) devices 514 may be coupled to first bus 516, along with a bus bridge 518 which couples first bus 516 to a second bus 520. Various devices may be coupled to second bus 520 including, for example, a keyboard/mouse 522, communication devices 526 and a data storage unit 528 such as a disk drive or other mass storage device which may include code 530, in one embodiment. Further, an audio I/O 524 may be coupled to second bus 520.

Embodiments may be implemented in code and may be stored on a storage medium having stored thereon instructions which can be used to program a system to perform the instructions. The storage medium may include, but is not limited to, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
creating a control flow graph (CFG) node for a starting address;
parsing code beginning at the starting address until a control transfer is encountered; and
statically determining a destination address for the control transfer, and creating a CFG node for the destination address, and parsing code beginning therefrom.

2. The method of claim 1, further comprising iteratively creating CFG nodes and parsing code for a plurality of starting addresses, the plurality of starting addresses including a binary entry point and at least one function address obtained from a symbol table.

3. The method of claim 2, wherein the plurality of starting addresses further include each byte of a code segment, wherein each byte is considered a constant.

4. The method of claim 2, further comprising filtering redundant basic blocks of the CFG nodes.

5. The method of claim 4, wherein the filtering includes invalidating a first CFG node that contains an instruction that encodes as a zero value.

6. The method of claim 5, wherein the filtering includes marking a second CFG node invalid that includes a privileged instruction.

7. The method of claim 6, wherein the filtering includes marking a third CFG node invalid that includes a memory reference to a non-application memory space.

8. The method of claim 4, wherein the filtering includes iteratively marking a plurality of the CFG nodes invalid, in which the plurality of CFG nodes are predecessors of an invalid CFG node.

9. An article comprising a machine-accessible storage medium including instructions that when executed cause a system to:
receive an entry point to a code segment and create a control flow graph (CFG) node for the code segment;
parse the code segment beginning at the entry point for constants and select at least some of the constants to be start points; and
thereafter parse code beginning at the selected start points to create additional CFG nodes.

10. The article of claim 9, further comprising instructions that when executed enable the system to filter the additional CFG nodes to remove any redundant ones of the additional CFG nodes.

11. The article of claim 10, further comprising instructions that when executed enable the system to invalidate a first CFG node that contains an instruction that encodes as a zero value, invalidate a second CFG node that includes a privileged instruction, and invalidate a third CFG node that includes a memory reference to a non-application memory space.

12. The article of claim 10, further comprising instructions that when executed enable the system to iteratively mark a plurality of the additional CFG nodes invalid, in which the plurality of the additional CFG nodes are predecessors of an invalid CFG node.

13. The article of claim 10, further comprising instructions that when executed enable the system to parse the code segment until a control transfer is encountered, and statically determine a destination address for the control transfer, and create a CFG node for the destination address, and parse code beginning therefrom.

14. The article of claim 9, further comprising instructions that when executed enable the system to iteratively create CFG nodes and parse code for a plurality of starting addresses, the plurality of starting addresses including at least one function address obtained from a symbol table.

15. A system comprising:
a processor to execute instructions, the processor including a binary translator to translate code of a first instruction set architecture (ISA) to a native ISA, the binary translator to create a control flow graph (CFG) node for a starting address, parse code beginning at the starting address until a control transfer is encountered, statically determine a destination address for the control transfer and create a CFG node for the destination address, and parse code beginning therefrom; and
a dynamic random access memory (DRAM) coupled to the processor.

16. The system of claim 15, wherein the binary translator is to iteratively create CFG nodes and parse code for a plurality of starting addresses, the plurality of starting addresses including at least one function address obtained from a symbol table.

17. The system of claim 16, wherein the binary translator is to filter redundant basic blocks of the CFG nodes.

18. The system of claim 17, wherein the binary translator is to invalidate a first CFG node that contains an instruction that encodes as a zero value, invalidate a second CFG node that includes a privileged instruction, and invalidate a third CFG node that includes a memory reference to a non-application memory space.

19. The system of claim 17, wherein the binary translator is to iteratively invalidate a plurality of the CFG nodes, wherein the plurality of CFG nodes are predecessors of an invalid CFG node.
